(19) United States
(12) Patent Application Publication
(10) Pub. No.: US 2008/0277241 A1
(43) Pub. Date: Nov. 13, 2008

(54) Chute Connection / Protection Assembly

(76) Inventors: Thomas John Bruzenak, Salt Lake City, UT (US); Derral Jay Allen, West Valley City, UT (US)

Correspondence Address: THOMAS J. BRUZENAK, 2402 PROMONTORY DR., SALT LAKE CITY, UT, 84109, US

(21) Appl. No.: 11/747,906

(22) Filed: May 13, 2007

(51) Int. Cl. B65G 11/00; B65G 11/20

(52) U.S. Cl. 193/2 A; 193/2 R

(57) ABSTRACT

The chute connection assembly is designed and sized to carry large loads and any number of chutes that may need to be connected to one another.

The chute protection assembly is designed to protect chute entrance and exit material from damage.

### CROSS-REFERENCE TO RELATED APPLICATIONS

### U.S. Patent Documents

| | | |
|---|---|---|
| 176700 | April 1876 | Sible |
| 556934 | March 1896 | Koller |
| 2968382 | January 1961 | Oury |
| 3157262 | November 1964 | Chapdelaine |
| 3310293 | Mar. 21, 1967 | Zimmerman |
| 3334872 | August 1967 | Hansen et al. |
| 3774741 | November 1973 | Johnson |
| 4047604 | September 1977 | Daoust et al. |
| 4073318 | February 1978 | Close et al. |
| 4875569 | Oct. 24, 1984 | Oury, et al. |
| 4711334 | Dec. 8, 1987 | Barry, et al. |
| 5015122 | May 1991 | Combes |
| 5035313 | July 1991 | Smith |
| 5178252 | January 1993 | Smith |
| 5192178 | March 1993 | Silbernagel |
| 5551776 | September 1996 | Zimmerman |
| 6186304 | Feb. 13, 2001 | H.ang.kansson |
| 6280119 | Aug. 28, 2001 | Ryan, et al. |
| 20030226737 | Dec. 11, 2003 | Quigley, Thomas P.; et al. |
| 20040154898 | Aug. 12, 2004 | Mc Vay, David Wayne; et al. |
| 6868953 | Mar. 22, 2005 | Thompson |

### STATEMENT REGARDING FEDERALLY SPONSORED RESEARCH OR DEVELOPMENT

Not Applicable.

### REFERENCE TO SEQUENCE LIST, A TABLE, OR A COMPUTER PROGRAM LISTING COMPACT DISC APPENDIX

Not Applicable.

### BACKGROUND OF THE INVENTION

In the past and most recent future, steel and aluminum chutes used similar material at the entrance and exit for the chute connections. There is a need for a universal chute connection/protection assembly, which can be used on any type of chute construction material that can be bonded or wielded. The components can be sized to carry heavy loads and multiple chutes to be connected to one another.

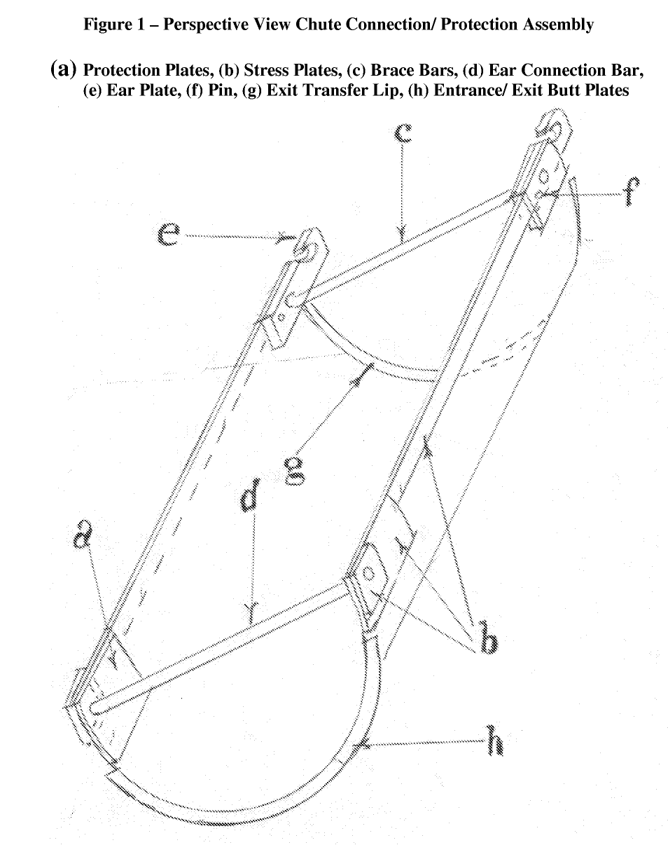

The chute connection/protection assembly herein and so claimed is made from any combination of materials and is bonded or wielded to the chute material. The chute material can be steel, aluminum, plastic or fiber-reinforced material. The chute connection assembly is contained in section 1 and the chute protection assembly is contained in section 2. FIGS. 1, 2, 3 are referenced in both Section 1 and Section 2.

FIG. 1—Perspective view of chute connection/protection assembly.

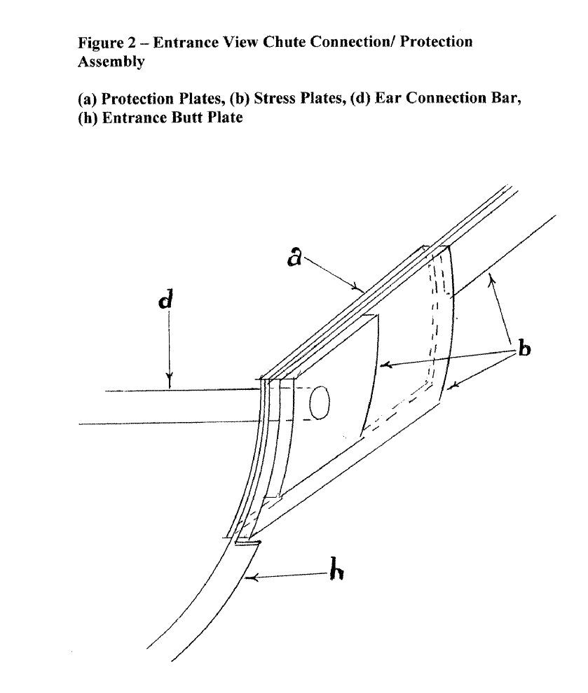

FIG. 2—Entrance view of chute connection/protection assembly.

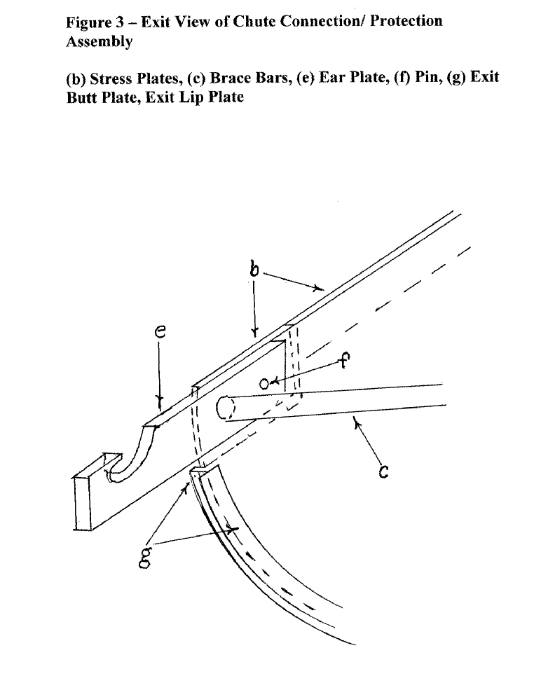

FIG. 3—Exit view of chute connection/protection assembly.

Drawing depicts bonding and wielding.

### Section 1.

### Connection Assembly:

By using a dissimilar material from the chute and selecting an appropriate bonding adhesive material which can carry the load and by increasing the bondable area and/or strength characteristics of the components large loads and any number of chutes can be connected to one another.

### Section 2.

### Protection Assembly:

By using a stronger but dissimilar material from the chute or if a composite is selected for the butt plates than the fibers are perpendicular to the chute this technique protects the softer chute material or the chute liner from damage.

### DETAILED DESCRIPTION OF THE INVENTION

The present invention will become more fully understood from the detailed description herein given below by way of illustration only, and thus do not limit the present invention and wherein:

### Section 1.

### Connection Assembly:

### Entrance:

1. The stress plate (or box) (FIG. 1b) transfers the load to the chute walls from the ear connection bar. The number or the thickness of stress plates (bonded or wielded together to form a box) is determined by load factors. The stress plates (or box) is bonded and or pined to the chute walls.
2. The ear connection bar (FIG. 1d) must be of material and sized to carry the full load of the chute(s) and the material being transported and may be wielded, bonded or threaded (if bolted) to the stress plates (or box).
3. The ear plate (FIG. 1e) material must carry the chute(s) load and material being transported through the chute.
4. The stress plates (or box) (FIG. 1b) transfers the load to the chute walls from the ear plate (FIG. 1e). The number of stress plates (or box) and thickness or type of material is determined by load factors. The stress plate (or box) is bonded and/or pined to the chute wall. Sequence 1-4 creates an entrance.

### Exit:

5. The pin (FIG. 1f) or bolt or rod secures the ear plate or box (FIG. 1e) to the chute wall and must have sufficient cross-surface area to carry the load.
6. The brace bar(s) (FIG. 1c) stops the load being placed upon the bottom of the chute from collapsing and is determined by the chute wall flexibility and may be wielded or bonded to the stress plates (or box) or some other region of the chute. Multiple stress plates are either wielded or bonded together to provide additional strength and may be wielded together to form a box. A brace bar wielded to entrance stress plates and to exit stress plates will be required if chute is designed for large loads.
7. Exit Lip plate also called the transfer lip (FIG. 1g) material need be no stronger than the full load force applied to the chute. Not necessary if this is the last or tail chute.
8. Sequence 5-7 creates an exit and forms the mating connection to the entrance to another identical chute thereby allowing any number of chutes to be connected to one another.

### Section 2.

### Protection Assembly:

9. Protection plate (FIG. 1a) material need be no larger than the ear plate and may be wielded together with the connection plates to form a box.
10. Entrance or Exit Butt plate (FIG. 1h) material need be no stronger than the full load force applied to the chute.

Although a preferred embodiment has been described and shown in the drawings sufficiently to allow those skilled in the art to both build and use my chute connection/protection assembly, it is to be understood that various modifications may and probably will be practiced in the device, and that these modifications may be made without departing from the spirit of the appended claims.

What is claimed is: Section 1: Connection Assembly:

I. Entrance: Protection plates (if necessary) having holes (FIG. 1a) and a stress plate (FIG. 1b) (if necessary) (may be wielded together to form a box) having holes so placed that the ear connection bar (FIG. 1d) and if necessary the brace bar (FIG. 1c) and pins can be inserted through the plates (or box). The brace bar and the ear connection bar are either wielded into the box or bonded together. The chute material is sandwiched and bonded (and pined) between the two plates (or box) on each side of the entrance to the chute. The ear connection bar is either bonded, wielded to the plates or the box, or if threaded bolted in place. This section forms the connection at the entrance to the chute.

II. Exit: Ear plates (FIG. 1e) and stress plates (FIG. 1b) (may be wielded together to form a box) having holes for pins are so placed that the brace bar (FIG. 1c) bolted, wielded or bonded and the pins or bolt (FIG. 1f) can be inserted through the plates or box. The chute material is sandwiched and bonded between the two plates (or box) forming the connection at the exit of the chute. Multiple stress plates are either wielded or bonded together to provide additional strength. The Exit Transfer Lip (FIG. 1g) follows the radius of chute exit and provides a method of material transfer from the exit of one chute unto the entrance of the next chute.
Section 2.
Protection Assembly:

III. The Entrance or Exit Butt Plate (FIG. 1h) L or channel is bent or molded to follow the radius of chute entrance or exit and covers the chute material or if molded is perpendicular to entrance or exit. This component provides the protection to the weaker chute material.
